(19) United States
(12) Patent Application Publication
(10) Pub. No.: US 2009/0302553 A1
(43) Pub. Date: Dec. 10, 2009

(54) Watertight navigation device

(76) Inventor: Kay Soon Tan, Singapore (SG)

Correspondence Address: COHEN, PONTANI, LIEBERMAN & PAVANE LLP, 551 FIFTH AVENUE, SUITE 1210, NEW YORK, NY, 10176, US

(21) Appl. No.: 12/309,002

(22) PCT Filed: Jun. 29, 2007
(86) PCT No.: PCT/EP2007/056578

§ 371 Date: Dec. 31, 2008

(30) Foreign Application Priority Data
Jul. 31, 2006 (EP) 06013763.5

(51) Int. Cl. A47B 81/00; F16J 15/10

(52) U.S. Cl. 277/652; 312/223.1

(57) ABSTRACT

A watertight navigation device comprises a watertight housing which accommodates a display and comprises a transparent watertight panel which covers the display towards the outside of the watertight housing. The transparent watertight panel works as a panel-type speaker, the watertight housing and the transparent watertight panel being sealingly coupled with each other.

The invention relates to a navigation device comprising a housing, a display and a panel which covers the display towards the outside of the housing.

US 2006/0012559 A1 discloses a speaker apparatus for a mobile communications terminal. The speaker apparatus includes a display window which acts as a speaker by using the display window as a vibration plate. As a result, sound in lower frequency range can be reproduced. In addition through the use of filters, frequency characteristics can be further enhanced.

US 2006/0022958 A1 discloses a touch panel input device having a function for providing vibrations. The touch panel input device includes a touch panel receiving an operation on an operation item on a display panel, a vibration controlling unit vibrating the touch panel, an operation detector detecting an operation on the touch panel and an operation mode controlling unit. The operation mode controlling unit sets an operation mode of the touch panel to an input operation for vibrating the touch panel upon detecting a touch on the touch panel, or either a speaker mode for vibrating the touch panel to produce sounds or a microphone mode for allowing a voice input by transmitting vibrations generated to the touch panel when the operator speaks to the touch panel. The operation mode controlling unit changes the operation mode to the input operation mode when the operation is set to the speaker mode or the microphone mode upon detecting an operation on the touch panel.

It is an object of the invention to create a watertight navigation device in a simple way.

The object is achieved by the features of the independent claim 1. Advantageous embodiments of the invention are explained in the sub-claims.

The invention is distinguished by a watertight navigation device. The watertight navigation device comprises a watertight housing and a transparent watertight panel. The watertight housing takes in a display. The transparent watertight panel covers the display towards the outside of the watertight housing. A transparent watertight panel works as a panel type speaker. The watertight housing and the transparent watertight panel are sealingly coupled with each other.

This enables not to arrange any common speaker which needs holes in the watertight housing and which needs much space in the navigation device. This contributes to make the watertight navigation device watertight in a simple way. Further, this enables to create a compact watertight navigation device.

In an advantageous embodiment of the watertight navigation device, the transparent panel works as a touch panel. This enables to input data into the watertight navigation device without any buttons. This contributes to make the navigation device watertight in a simple way.

In a further advantageous embodiment of the watertight navigation device, the watertight navigation device comprises a first gasket which is formed and arranged between the watertight housing and the transparent watertight panel. This contributes to make the watertight navigation device watertight in an easy way.

In a further advantageous embodiment of the watertight navigation device, the watertight navigation device comprises at least one button which is watertightly arranged in an opening of the watertight housing. This enables an input into the navigation device outside of the watertight panel. For example, the button is a power on/off button.

In a further advantageous embodiment of the watertight navigation device, the watertight navigation device comprises a second gasket which is formed and arranged between the watertight housing and the watertight button for sealing up the navigation device. This contributes to make the navigation device watertight in an easy way.

In a further advantageous embodiment of the watertight navigation device, the watertight housing comprises at least one compartment with a compartment cover. This may enable a change of a battery and/or of a GPS antenna and/or, in case, this may enable a service of the navigation device in a simple way.

In a further advantageous embodiment of the watertight navigation device, a third gasket is formed and arranged between the watertight housing and/or the compartment cover. This contributes to make the navigation watertight in an easy way.

The invention is explained in the following with the help of schematic drawings.

These are as follows:

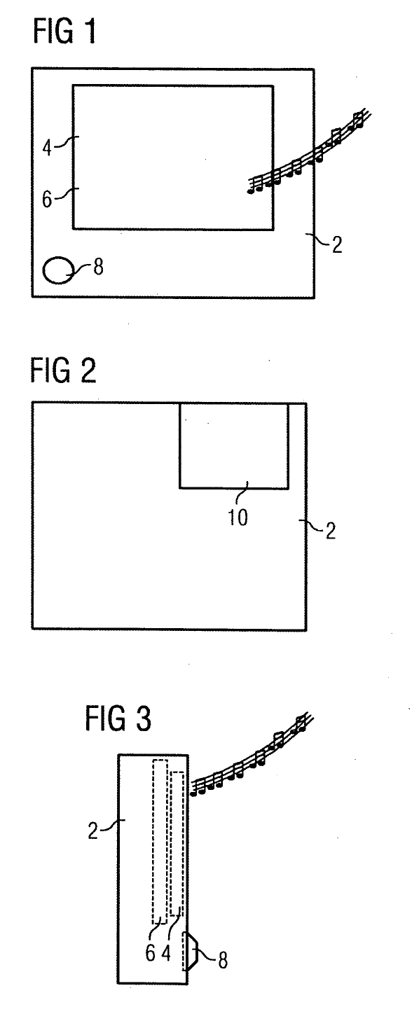

FIG. 1 a front view of a watertight navigation device,

FIG. 2 a back view of the watertight navigation device,

FIG. 3 a side view of the watertight navigation device.

Elements with the same design or function that appear in the different illustrations are identified by the same reference characters.

A watertight navigation device (FIG. 1) comprises a watertight housing 2, a transparent watertight panel 4, and a display 6. For example, the display 6 is an LCD display.

The transparent watertight panel 4 covers the display 6 towards the outside of the watertight navigation device (FIG. 3). Preferably, a first gasket is arranged between the watertight housing 2 and the watertight transparent panel 4 for sealing up the watertight navigation device against water. The first gasket and, in case, further gaskets may comprise a thermoplastic rubber.

The watertight navigation device may comprise a button 8. Preferably, the button 8 is watertight and an on/off button 8 to shut on/off the watertight navigation device. Preferably, a second gasket is arranged between the button 8 and the watertight housing 2 for sealing up the watertight navigation device against water. Alternatively, the button 8 may be covered with a lamination for sealing up the recess for the button 8 in the watertight housing 2. The lamination may comprise rubber.

The transparent watertight panel 4 may be used as a panel type speaker. Therefore, the watertight navigation device comprises means for vibrating the watertight transparent panel 4 in such a way that a sound is created by the vibrating watertight transparent panel 4. This enables not to arrange a common speaker. This enables to leave out holes in the watertight housing 2 which would be necessary if the navigation device would have the common speaker. So, there are no holes in the watertight housing 2 which would have to be sealed against the environment of the watertight navigation device. This contributes to make the watertight navigation device watertight while having a simple design of the watertight navigation device.

Preferably, the watertight transparent panel 4 also works as a touch panel. This enables to reduce the amount of buttons 8 to only one button 8 while being able to use the full functionality of the watertight navigation device. The fewer buttons 8 there are the fewer holes have to be drilled in the watertight housing 2 and the fewer gaskets have to be arranged. This contributes to make the watertight navigation device watertight in an easy way and reduces the amount of work and costs for producing the watertight navigation device.

Further, the watertight navigation device preferably comprises a compartment with a compartment cover 10 (FIG. 2). The compartment may be used for taking in at least one battery, a GPS-antenna or any other position recognition system. Further, the compartment may enable a simple service of the watertight navigation device. Preferably, there is arranged a third gasket between the watertight housing 2 and the compartment cover for sealing up the watertight navigation device.

Preferably, the watertight housing 2, the watertight transparent panel 4, and the button 8 are the only parts of the watertight navigation device which are exposed to the environmental conditions and which, in case, come in contact with, for example water.

The invention is not restricted by the explained embodiments. For example, the watertight navigation device may comprise one or more further compartments and/or one or more further buttons 8 (FIG. 3).

1.-7. (canceled)

8. A watertight navigation device, comprising:
a watertight housing;
a display accommodated in said housing; and
a transparent watertight panel covering said display toward an outside of the watertight housing, said panel being operable as a panel-type speaker and being sealingly coupled with said housing.

9. The watertight navigation device of claim 8, wherein said panel is a touch panel.

10. The watertight navigation device of claim 8, further comprising a first gasket arranged between said panel and said housing.

11. The watertight navigation device of claim 8, further comprising a button arranged watertight in an opening of housing.

12. The watertight navigation device of claim 11, further comprising a button gasket arranged between said button and said housing for sealing the navigation device.

13. The watertight navigation device of claim 8, further comprising a compartment cover sealingly covering a compartment in said housing.

14. The watertight navigation device of claim 13, further comprising a compartment gasket arranged between said compartment cover and said housing.

15. The watertight navigation device of claim 9, further comprising a button arranged watertightly in an opening of said housing.

16. The watertight navigation device of claim 15, wherein said button is an on/off button configured to at least one of turn on and shut off said navigation device.
